(19) United States
(12) Patent Application Publication
(10) Pub. No.: US 2012/0294446 A1
(43) Pub. Date: Nov. 22, 2012

(54) BLIND SOURCE SEPARATION BASED SPATIAL FILTERING

(75) Inventors: Erik Visser, San Diego, CA (US); Lae-Hoon Kim, San Diego, CA (US); Pei Xiang, San Diego, CA (US)

(73) Assignee: QUALCOMM Incorporated, San Diego, CA (US)

(21) Appl. No.: 13/370,934

(22) Filed: Feb. 10, 2012

Related U.S. Application Data
(60) Provisional application No. 61/486,717, filed on May 16, 2011.

(51) Int. Cl. H04R 5/00

(52) U.S. Cl. 381/17

(57) ABSTRACT

A method for blind source separation based spatial filtering on an electronic device includes obtaining a first source audio signal and a second source audio signal. The method also includes applying a blind source separation filter set to the first source audio signal and to the second source audio signal to produce a spatially filtered first audio signal and a spatially filtered second audio signal. The method further includes playing the spatially filtered first audio signal over a first speaker to produce an acoustic spatially filtered first audio signal and playing the spatially filtered second audio signal over a second speaker to produce an acoustic spatially filtered second audio signal. The acoustic spatially filtered first audio signal and the acoustic spatially filtered second audio signal produce an isolated acoustic first source audio signal at a first position and an isolated acoustic second source audio signal at a second position.

### RELATED APPLICATIONS

This application is related to and claims priority from U.S. Provisional Patent Application Ser. No. 61/486,717 filed May 16, 2011, for “BLIND SOURCE SEPARATION BASED SPATIAL FILTERING.”

### TECHNICAL FIELD

The present disclosure relates generally to audio systems. More specifically, the present disclosure relates to blind source separation based spatial filtering.

### BACKGROUND

In the last several decades, the use of electronics has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronics. More specifically, electronic devices that perform new functions or that perform functions faster, more efficiently or with higher quality are often sought after.

Some electronic devices use audio signals to function. For instance, some electronic devices capture acoustic audio signals using a microphone and/or output acoustic audio signals using a speaker. Some examples of electronic devices include televisions, audio amplifiers, optical media players, computers, smartphones, tablet devices, etc.

When an electronic device outputs an acoustic audio signal with a speaker, a user may hear the acoustic audio signal with both ears. When two or more speakers are used to output audio signals, the user may hear a mixture of multiple audio signals in both ears. The way in which the audio signals are mixed and perceived by a user may further depend on the acoustics of the listening environment and/or user characteristics. Some of these effects may distort and/or degrade the acoustic audio signals in undesirable ways. As can be observed from this discussion, systems and methods that help to isolate acoustic audio signals may be beneficial.

### SUMMARY

A method for blind source separation based spatial filtering on an electronic device is disclosed. The method includes obtaining a first source audio signal and a second source audio signal. The method also includes applying a blind source separation filter set to the first source audio signal and to the second source audio signal to produce a spatially filtered first audio signal and a spatially filtered second audio signal. The method further includes playing the spatially filtered first audio signal over a first speaker to produce an acoustic spatially filtered first audio signal. The method additionally includes playing the spatially filtered second audio signal over a second speaker to produce an acoustic spatially filtered second audio signal. The acoustic spatially filtered first audio signal and the acoustic spatially filtered second audio signal produce an isolated acoustic first source audio signal at a first position and an isolated acoustic second source audio signal at a second position. The blind source separation may be independent vector analysis (IVA), independent component analysis (ICA) or a multiple adaptive decorrelation algorithm. The first position may correspond to one ear of a user and the second position corresponds to another ear of the user.

The method may also include training the blind source separation filter set. Training the blind source separation filter set may include receiving a first mixed source audio signal at a first microphone at the first position and second mixed source audio signal at a second microphone at the second position. Training the blind source separation filter set may also include separating the first mixed source audio signal and the second mixed source audio signal into an approximated first source audio signal and an approximated second source audio signal using blind source separation. Training the blind source separation filter set may additionally include storing transfer functions used during the blind source separation as the blind source separation filter set for a location associated with the first position and the second position.

The method may also include training multiple blind source separation filter sets, each filter set corresponding to a distinct location. The method may further include determining which blind source separation filter set to use based on user location data.

The method may also include determining an interpolated blind source separation filter set by interpolating between the multiple blind source separation filter sets when a current location of a user is in between the distinct locations associated with the multiple blind source separation filter sets. The first microphone and the second microphone may be included in a head and torso simulator (HATS) to model a user's ears during training.

The training may be performed using multiple pairs of microphones and multiple pairs of speakers. The training may be performed for multiple users.

The method may also include applying the blind source separation filter set to the first source audio signal and to the second source audio signal to produce multiple pairs of spatially filtered audio signals. The method may further include playing the multiple pairs of spatially filtered audio signals over multiple pairs of speakers to produce the isolated acoustic first source audio signal at the first position and the isolated acoustic second source audio signal at the second position.

The method may also include applying the blind source separation filter set to the first source audio signal and to the second source audio signal to produce multiple spatially filtered audio signals. The method may further include playing the multiple spatially filtered audio signals over a speaker array to produce multiple isolated acoustic first source audio signals and multiple isolated acoustic second source audio signals at multiple position pairs for multiple users.

An electronic device configured for blind source separation based spatial filtering is also disclosed. The electronic device includes a processor and instructions stored in memory that is in electronic communication with the processor. The electronic device obtains a first source audio signal and a second source audio signal. The electronic device also applies a blind source separation filter set to the first source audio signal and to the second source audio signal to produce a spatially filtered first audio signal and a spatially filtered second audio signal. The electronic device further plays the spatially filtered first audio signal over a first speaker to produce an acoustic spatially filtered first audio signal. The electronic device additionally plays the spatially filtered second audio signal over a second speaker to produce an acoustic spatially filtered second audio signal. The acoustic spatially filtered first audio signal and the acoustic spatially filtered second audio signal produce an isolated acoustic first source audio signal at a first position and an isolated acoustic second source audio signal at a second position.

A computer-program product for blind source separation based spatial filtering is also disclosed. The computer-program product includes a non-transitory tangible computer-readable medium with instructions. The instructions include code for causing an electronic device to obtain a first source audio signal and a second source audio signal. The instructions also include code for causing the electronic device to apply a blind source separation filter set to the first source audio signal and to the second source audio signal to produce a spatially filtered first audio signal and a spatially filtered second audio signal. The instructions further include code for causing the electronic device to play the spatially filtered first audio signal over a first speaker to produce an acoustic spatially filtered first audio signal. The instructions additionally include code for causing the electronic device to play the spatially filtered second audio signal over a second speaker to produce an acoustic spatially filtered second audio signal. The acoustic spatially filtered first audio signal and the acoustic spatially filtered second audio signal produce an isolated acoustic first source audio signal at a first position and an isolated acoustic second source audio signal at a second position.

An apparatus for blind source separation based spatial filtering is also disclosed. The apparatus includes means for obtaining a first source audio signal and a second source audio signal. The apparatus also includes means for applying a blind source separation filter set to the first source audio signal and to the second source audio signal to produce a spatially filtered first audio signal and a spatially filtered second audio signal. The apparatus further includes means for playing the spatially filtered first audio signal over a first speaker to produce an acoustic spatially filtered first audio signal. The apparatus additionally includes means for playing the spatially filtered second audio signal over a second speaker to produce an acoustic spatially filtered second audio signal. The acoustic spatially filtered first audio signal and the acoustic spatially filtered second audio signal produce an isolated acoustic first source audio signal at a first position and an isolated acoustic second source audio signal at a second position.

### BRIEF DESCRIPTION OF THE DRAWINGS

FIG. 1 is a block diagram illustrating one configuration of an electronic device for blind source separation (BSS) filter training;

FIG. 2 is a block diagram illustrating one configuration of an electronic device for blind source separation (BSS) based spatial filtering;

FIG. 3 is a flow diagram illustrating one configuration of a method for blind source separation (BSS) filter training;

FIG. 4 is a flow diagram illustrating one configuration of a method for blind source separation (BSS) based spatial filtering;

FIG. 5 is a diagram illustrating one configuration of blind source separation (BSS) filter training;

FIG. 6 is a diagram illustrating one configuration of blind source separation (BSS) based spatial filtering;

FIG. 7 is a block diagram illustrating one configuration of training and runtime in accordance with the systems and methods disclosed herein;

FIG. 8 is a block diagram illustrating one configuration of an electronic device for blind source separation (BSS) based filtering for multiple locations;

FIG. 9 is a block diagram illustrating one configuration of an electronic device for blind source separation (BSS) based filtering for multiple users or head and torso simulators (HATS); and

FIG. 10 illustrates various components that may be utilized in an electronic device.

### DETAILED DESCRIPTION

Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, and/or selecting from a set of values. Unless expressly limited by its context, the term “obtaining” is used to indicate any of its ordinary meanings, such as calculating, deriving, receiving (e.g., from an external device), and/or retrieving (e.g., from an array of storage elements). Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Similarly, the term “in response to” is used to indicate any of its ordinary meanings, including “in response to at least.”

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, or system as indicated by its particular context. The terms “method,” “process,” “procedure,” and “technique” are used generically and interchangeably unless otherwise indicated by the particular context. The terms “apparatus” and “device” are also used generically and interchangeably unless otherwise indicated by the particular context. The terms “element” and “module” are typically used to indicate a portion of a greater configuration. Any incorporation by reference of a portion of a document shall also be understood to incorporate definitions of terms or variables that are referenced within the portion, where such definitions appear elsewhere in the document, as well as any figures referenced in the incorporated portion.

Binaural stereo sound images may give a user the impression of a wide sound field and further immerse the user into the listening experience. Such a stereo image may be achieved by wearing a headset. However, this may not be comfortable for prolonged sessions and be impractical for some applications. To achieve a binaural stereo image at a user's ear in front of a speaker array, head-related transfer function (HRTF) based inverse filters may be computed where an acoustic mixing matrix may be selected based on HRTFs from a database as a function of a user's look direction. This mixing matrix may be inverted offline and the resulting matrix applied to left and right sound images online. This may also referred to as crosstalk cancellation.

Traditional HRTF-based approaches may have some disadvantages. For example, the HRTF inversion is a model-based approach where transfer functions may be acquired in a lab (e.g., in an anechoic chamber with standardized loudspeakers). However, people and listening environments have unique attributes and imperfections (e.g., people have differently shaped faces, heads, ears, etc.). All these things affect the travel characteristics through the air (e.g., the transfer function). Therefore, the HRTF approach may not model the actual environment very well. For example, the particular furniture and anatomy of a listening environment may not be modeled exactly by the HRTFs.

The present systems and methods may be used to compute spatial filters by learning blind source separation (BSS) filters applied to mixture data. For example, the systems and methods disclosed herein may provide speaker array based binaural imaging using BSS designed spatial filters. The unmixing BSS solution decorrelates head and torso simulator (HATS) or user ear recorded inputs into statistically independent outputs and implicitly inverts the acoustic scenario. A HATS may be a mannequin with two microphones positioned to simulate a user's ear position(s). Using this approach, inherent crosstalk cancellation problems such as head-related transfer function (HRTF) mismatch (non-individualized HRFT), additional distortion by loudspeaker and/or room transfer function may be avoided. Furthermore, a listening “sweet spot” may be enlarged by allowing microphone positions (corresponding to a user, a HATS, etc.) to move slightly around nominal positions during training.

In an example with BSS filters computed using two independent speech sources, it is shown that HRTF and BSS spatial filters exhibit similar null beampatterns and that the crosstalk cancellation problem addressed by the present systems and methods may be interpreted as creating null beams of each stereo source to one ear.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

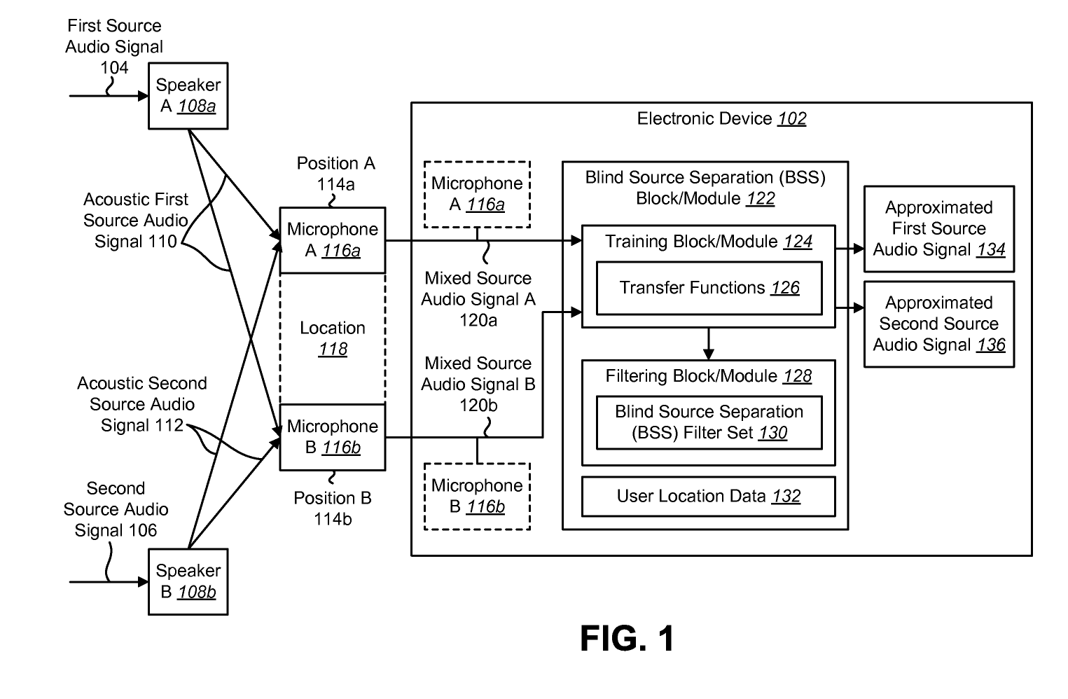

FIG. 1 is a block diagram illustrating one configuration of an electronic device 102 for blind source separation (BSS) filter training. Specifically, FIG. 1 illustrates an electronic device 102 that trains a blind source separation (BSS) filter set 130. It should be noted that the functionality of the electronic device 102 described in connection with FIG. 1 may be implemented in a single electronic device or may be implemented in a plurality of separate electronic devices. Examples of electronic devices include cellular phones, smartphones, computers, tablet devices, televisions, audio amplifiers, audio receivers, etc. Speaker A 108a and speaker B 108b may receive a first source audio signal 104 and a second source audio signal 106, respectively. Examples of speaker A 108a and speaker B 108b include loudspeakers. In some configurations, the speakers 108a-b may be coupled to the electronic device 102. The first source audio signal 104 and the second source audio signal 106 may be received from a portable music device, a wireless communication device, a personal computer, a television, an audio/visual receiver, the electronic device 102 or any other suitable device (not shown).

The first source audio signal 104 and the second source audio signal 106 may be in any suitable format compatible with the speakers 108a-b. For example, the first source audio signal 104 and the second source audio signal 106 may be electronic signals, optical signals, radio frequency (RF) signals, etc. The first source audio signal 104 and the second source audio signal 106 may be any two audio signals that are not identical. For example, the first source audio signal 104 and the second source audio signal 106 may be statistically independent from each other. The speakers 108a-b may be positioned at any non-identical locations relative to a location 118.

During filter creation (referred to herein as training), microphones 116a-b may be placed in a location 118. For example, microphone A 116a may be placed in position A 114a and microphone B 116b may be placed in position B 114b. In one configuration, position A 114a may correspond to a user's right ear and position B 114b may correspond to a user's left ear. For example, a user (or a dummy modeled after a user) may wear microphone A 116a and microphone B 116b. For instance, the microphones 116a-b may be on a headset worn by a user at the location 118. Alternatively, microphone A 116a and microphone B 116b may reside on the electronic device 102 (where the electronic device 102 is placed in the location 118, for example). Examples of the electronic device 102 include a headset, a personal computer, a head and torso simulator (HATS), etc.

Speaker A 108a may convert the first source audio signal 104 to an acoustic first source audio signal 110. Speaker B 108b may convert the electronic second source audio signal 106 to an acoustic second source audio signal 112. For example, the speakers 108a-b may respectively play the first source audio signal 104 and the second source audio signal 106.

As the speakers 108a-b play the respective source audio signals 104, 106, the acoustic first source audio signal 110 and the acoustic second source audio signal 112 is received at the microphones 116a-b. The acoustic first source audio signal 110 and the acoustic second source audio signal 112 may be mixed when transmitted over the air from the speakers 108a-b to the microphones 116a-b. For example, mixed source audio signal A 120a may include elements from the first source audio signal 104 and elements from the second source audio signal 106. Additionally, mixed source audio signal B 120b may include elements from the second source audio signal 106 and elements of the first source audio signal 104.

Mixed source audio signal A 120a and mixed source audio signal B 120b may be provided to a blind source separation (BSS) block/module 122 included in the electronic device 102. From the mixed source audio signals 120a-b, the blind source separation (BSS) block/module 122 may approximately separate the elements of the first source audio signal 104 and elements of the second source audio signal 106 into separate signals. For example, the training block/module 124 may learn or generate transfer functions 126 in order to produce an approximated first source audio signal 134 and an approximated second source audio signal 136. In other words, the blind source separation block/module 122 may unmix mixed source audio signal A 120a and mixed source audio signal B 120b to produce the approximated first source audio signal 134 and the approximated second source audio signal 136. It should be noted that the approximated first source audio signal 134 may closely approximate the first source audio signal 104, while the approximated second source audio signal 136 may closely approximate the second source audio signal 106.

As used herein, the term “block/module” may be used to indicate that a particular element may be implemented in hardware, software or a combination of both.

For example, the blind source separation (BSS) block/module may be implemented in hardware, software or a combination of both. Examples of hardware include electronics, integrated circuits, circuit components (e.g., resistors, capacitors, inductors, etc.), application specific integrated circuits (ASICs), transistors, latches, amplifiers, memory cells, electric circuits, etc.

The transfer functions 126 learned or generated by the training block/module 124 may approximate inverse transfer functions from between the speakers 108a-b and the microphones 116a-b. For example, the transfer functions 126 may represent an unmixing filter. The training block/module 124 may provide the transfer functions 126 (e.g., the unmixing filter that corresponds to an approximate inverted mixing matrix) to the filtering block/module 128 included in the blind source separation block/module 122. For example, the training block/module 124 may provide the transfer functions 126 from the mixed source audio signal A 120a and the mixed source audio signal B 120b to the approximated first source audio signal 134 and the approximated second source audio signal 136, respectively, as the blind source separation (BSS) filter set 130. The filtering block/module 128 may store the blind source separation (BSS) filter set 130 for use in filtering audio signals.

In some configurations, the blind source separation (BSS) block/module 122 may generate multiple sets of transfer functions 126 and/or multiple blind source separation (BSS) filter sets 130. For example, sets of transfer functions 126 and/or blind source separation (BSS) filter sets 130 may respectively correspond to multiple locations 118, multiple users, etc.

It should be noted that the blind source separation (BSS) block/module 122 may use any suitable form of BSS with the present systems and methods. For example, BSS including independent vector analysis (IVA), independent component analysis (ICA), multiple adaptive decorrelation algorithm, etc., may be used. This includes suitable time domain or frequency domain algorithms. In other words, any processing technique capable of separating source components based on their property of being statistically independent may be used by the blind source separation (BSS) block/module 122.

While the configuration illustrated in FIG. 1 is described with two speakers 108a-b, the present systems and methods may utilize more than two speakers in some configurations. In one configuration with more than two speakers, the training of the blind source separation (BSS) filter set 130 may use two speakers at a time. For example, the training may utilize less than all available speakers.

After training the blind source separation (BSS) filter set(s) 130, the filtering block/module 128 may use the filter set(s) 130 during runtime to preprocess audio signals before they are played on speakers. These spatially filtered audio signals may be mixed in the air after being played on the speakers, resulting in approximately isolated acoustic audio signals at position A 114a and position B 114b. An isolated acoustic audio signal may be an acoustic audio signal from a speaker with reduced or eliminated crosstalk from another speaker. For example, a user at the location 118 may approximately hear an isolated acoustic audio signal (corresponding to a first audio signal) at his/her right ear at position A 114a while hearing another isolated acoustic audio signal (corresponding to a second audio signal) at his/her left ear at position B 114b. The isolated acoustic audio signals at position A 114a and at position B 114b may constitute a binaural stereo image.

During runtime, the blind source separation (BSS) filter set 130 may be used to pre-emptively spatially filter audio signals to offset the mixing that will occur in the listening environment (at position A 114a and position B 114b, for example). Furthermore, the blind source separation (BSS) block/module 122 may train multiple blind source separation (BSS) filter sets 130 (e.g., one per location 118). In such a configuration, the blind source separation (BSS) block/module 122 may use user location data 132 to determine a best blind source separation (BSS) filter set 130 and/or an interpolated filter set to use during runtime. The user location data 132 may be any data that indicates a location of a listener (e.g., user) and may be gathered using one or more devices (e.g., cameras, microphones, motion sensors, etc.).

One traditional way to achieve a binaural stereo image at a user's ear in front of a speaker array may use head-related transfer function (HRTF) based inverse filters. As used herein, the term “binaural stereo image” refers to a projection of a left stereo channel to the left ear (e.g., of a user) and a right stereo channel to the right ear (e.g., of a user). Specifically, an acoustic mixing matrix, based on HRTFs selected from a database as a function of user's look direction, may be inverted offline. The resulting matrix may then be applied to left and right sound images online. This process may also be referred to as crosstalk cancellation.

However, there may be problems with HRTF-based inverse filtering. For example, some of these HRTFs may be unstable. When the inverse of an unstable HRTF is determined, the whole filter may be unusable. To compensate for this, various techniques may be used to make a stable, invertible filter. However, these techniques may be computationally intensive and unreliable. In contrast, the present systems and methods may not explicitly require inverting the transfer function matrix. Rather, the blind source separation (BSS) block/module 122 learns different filters so the cross correlation between its output is reduced or minimized (e.g., so the mutual information between outputs, such as the approximated first source audio signal 134 and the approximated second source audio signal 136, is minimized). One or more blind source separation (BSS) filter sets 130 may then be stored and applied to source audio during runtime.

Furthermore, the HRTF inversion is a model-based approach where transfer functions are acquired in a lab (e.g., in an anechoic chamber with standardized loudspeakers). However, people and listening environments have unique attributes and imperfections (e.g., people have differently shaped faces, heads, ears, etc.). All these things affect the travel characteristics through the air (e.g., the transfer functions). Therefore, the HRTF may not model the actual environment very well. For example, the particular furniture and anatomy of a listening environment may not be modeled exactly by the HRTFs. In contrast, the present BSS approach is data driven. For example, the mixed source audio signal A 120a and mixed source audio signal B 120b may be measured in the actual runtime environment. That mixture includes the actual transfer function for the specific environment (e.g., it is improved or optimized it for the specific listening environment). Additionally, the HRTF approach may produce a tight sweet spot, whereas the BSS filter training approach may account for some movement by broadening beams, thus resulting in a wider sweet spot for listening.

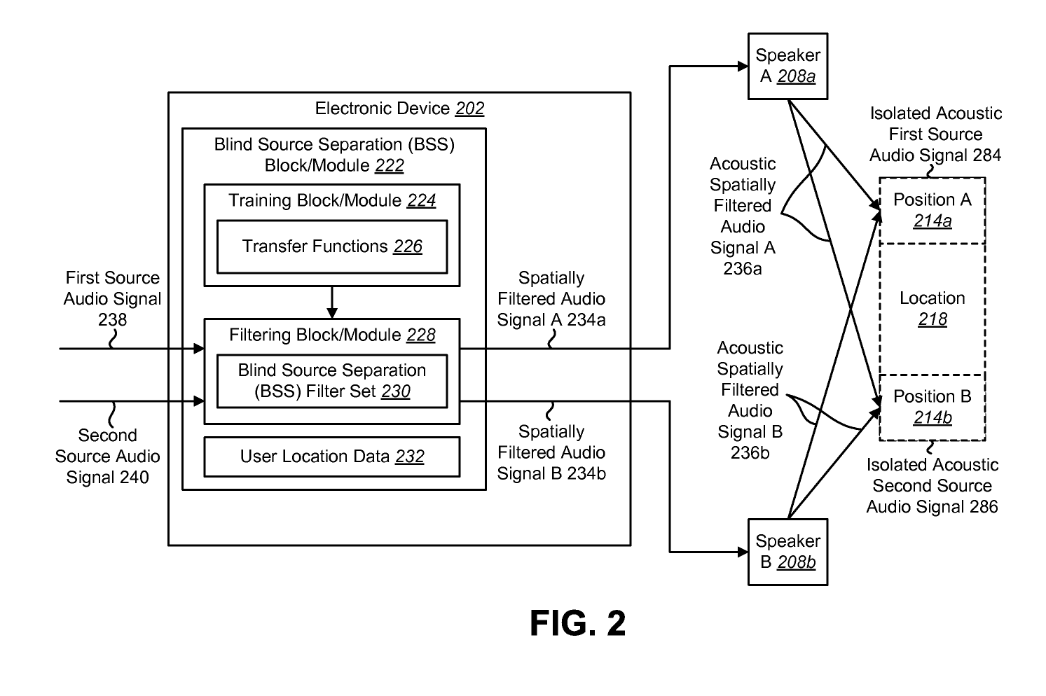

FIG. 2 is a block diagram illustrating one configuration of an electronic device 202 for blind source separation (BSS) based spatial filtering. Specifically, FIG. 2 illustrates an electronic device 202 that may use one or more previously trained blind source separation (BSS) filter sets 230 during runtime. In other words, FIG. 2 illustrates a playback configuration that applies the blind source separation (BSS) filter set(s) 230. It should be noted that the functionality of the electronic device 202 described in connection with FIG. 2 may be implemented in a single electronic device or may be implemented in a plurality of separate electronic devices. Examples of electronic devices include cellular phones, smartphones, computers, tablet devices, televisions, audio amplifiers, audio receivers, etc. The electronic device 202 may be coupled to speaker A 208a and speaker B 208b. Examples of speaker A 108a and speaker B 108b include loudspeakers. The electronic device 202 may include a blind source separation (BSS) block/module 222. The blind source separation (BSS) block/module 222 may include a training block/module 224, a filtering block/module 228 and/or user location data 232.

A first source audio signal 238 and a second source audio signal 240 may be obtained by the electronic device 202. For example, the electronic device 202 may obtain the first source audio signal 238 and/or the second source audio signal 240 from internal memory, from an attached device (e.g., a portable audio player, from an optical media player (e.g., compact disc (CD) player, digital video disc (DVD) player, Blu-ray player, etc.), from a network (e.g., local area network (LAN), the Internet, etc.), from a wireless link to another device, etc.

It should be noted that the first source audio signal 238 and the second source audio signal 240 illustrated in FIG. 2 may be from a source that is different from or the same as that of the first source audio signal 104 and the second source audio signal 106 illustrated in FIG. 1. For example, the first source audio signal 238 in FIG. 2 may come from a source that is the same as or different from that of the first source audio signal 104 in FIG. 1 (and similarly for the second source audio signal 240). For instance, the first source audio signal 238 and the second source audio signal 240 (e.g., some original binaural audio recording) may be input to the blind source separation (BSS) block/module 222.

The filtering block/module 228 in the blind source separation (BSS) block/module 222 may use an appropriate blind source separation (BSS) filter set 230 to preprocess the first source audio signal 238 and the second source audio signal 240 (before being played on speaker A 208a and speaker B 208b, for example). For example, the filtering block/module 228 may apply the blind source separation (BSS) filter set 230 to the first source audio signal 238 and the second source audio signal 240 to produce spatially filtered audio signal A 234a and spatially filtered audio signal B 234b. In one configuration, the filtering block/module 228 may use the blind source separation (BSS) filter set 230 determined previously according to transfer functions 226 learned or generated by the training block/module 224 to produce spatially filtered audio signal A 234a and spatially filtered audio signal B 234b that are played on the speaker A 208a and speaker B 208b, respectively.

In a configuration where multiple blind source separation (BSS) filter sets 230 are obtain according to multiple transfer function sets 226, the filtering block/module 228 may use user location data 232 to determine which blind source separation (BSS) filter set 230 to apply to the first source audio signal 238 and the second source audio signal 240.

Spatially filtered audio signal A 234a may then be played over speaker A 208a and spatially filtered audio signal B 234b may then be played over speaker B 208. For example, the spatially filtered audio signals 234a-b may be respectively converted (from electronic signals, optical signals, RF signals, etc.) to acoustic spatially filtered audio signals 236a-b by speaker A 208a and speaker B 208b. In other words, spatially filtered audio signal A 234a may be converted to acoustic spatially filtered audio signal A 236a by speaker A 208a and spatially filtered audio signal B 234b may be converted to acoustic spatially filtered audio signal B 236b by speaker B 208b.

Since the filtering (performed by the filtering block/module 228 using a blind source separation (BSS) filter set 230) corresponds to an approximate inverse of the acoustic mixing from the speakers 208a-b to position A 214a and position B 214b, the transfer function from the first and second source audio signals 238, 240 to the position A 214a and position B 214b (e.g., to a user's ears) may be expressed as an identity matrix. For example, a user at the location 218 including position A 214a and position B 214b may hear a good approximation of the first source audio signal 238 at one ear and the second source audio signal 240 at another ear. For instance, an isolated acoustic first source audio signal 284 may occur at position A 214a and an isolated acoustic second source audio signal 286 may occur at position B 214b by playing acoustic spatially filtered audio signal A 236a from speaker A 208a and acoustic spatially filtered audio signal B 236b at speaker B 208b. These isolated acoustic signals 284, 286 may produce a binaural stereo image at the location 218.

In other words, the blind source separation (BSS) training may produce blind source separation (BSS) filter sets 230 (e.g., spatial filter sets) as a byproduct that may correspond to the inverse of the acoustic mixing. These blind source separation (BSS) filter sets 230 may then be used for crosstalk cancelation. In one configuration, the present systems and methods may provide crosstalk cancellation and room inverse filtering, both of which may be trained for a specific user and acoustic space based on blind source separation (BSS).

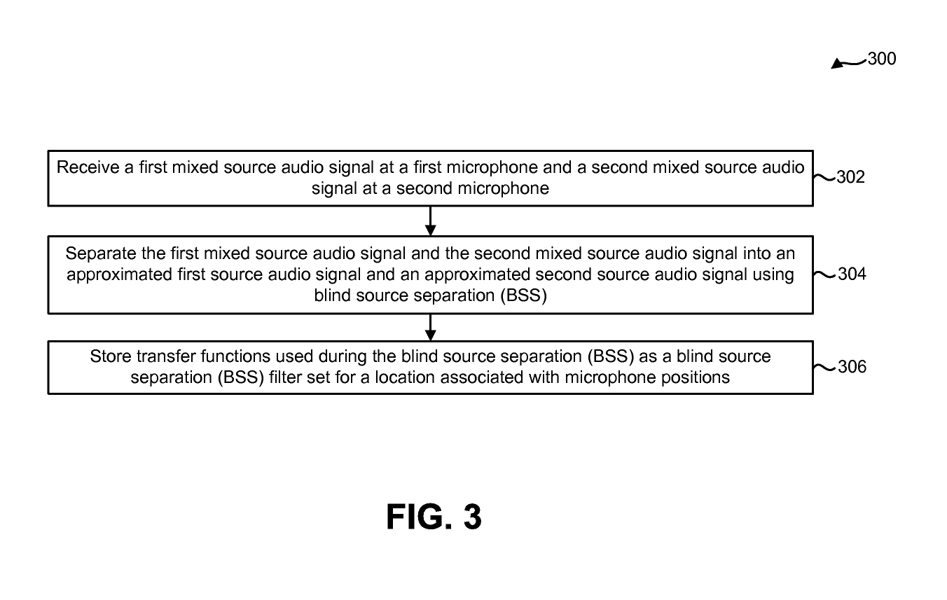

FIG. 3 is a flow diagram illustrating one configuration of a method 300 for blind source separation (BSS) filter training. The method 300 may be performed by an electronic device 102. For example, the electronic device 102 may train or generate one or more transfer functions 126 (to obtain one or more blind source separation (BSS) filter sets 130).

During training, the electronic device 102 may receive 302 mixed source audio signal A 120a from microphone A 116a and mixed source audio signal B 120b from microphone B 116b. Microphone A 116a and/or microphone B 116b may be included in the electronic device 102 or external to the electronic device 102. For example, the electronic device 102 may be a headset with included microphones 116a-b placed over the ears. Alternatively, the electronic device 102 may receive mixed source audio signal A 120a and mixed source audio signal B 120b from external microphones 116a-b. In some configurations, the microphones 116a-b may be located in a head and torso simulator (HATS) to model a user's ears or may be located a headset worn by a user during training, for example.

The mixed source audio signals 120a-b are described as “mixed” because their corresponding acoustic signals 110, 112 are mixed as they travel over the air to the microphones 116a-b. For example, mixed source audio signal A 120a may include elements from the first source audio signal 104 and elements from the second source audio signal 106. Additionally, mixed source audio signal B 120b may include elements from the second source audio signal 106 and elements from the first source audio signal 104.

The electronic device 102 may separate 304 mixed source audio signal A 120a and mixed source audio signal B 120b into an approximated first source audio signal 134 and an approximated second source audio signal 136 using blind source separation (BSS) (e.g., independent vector analysis (IVA), independent component analysis (ICA), multiple adaptive decorrelation algorithm, etc.). For example, the electronic device 102 may train or generate transfer functions 126 in order to produce the approximated first source audio signal 134 and the approximated second source audio signal 136.

The electronic device 102 may store 306 transfer functions 126 used during blind source separation as a blind source separation (BSS) filter set 130 for a location 118 associated with the microphone 116a-b positions 114a-b. The method 300 illustrated in FIG. 3 (e.g., receiving 302 mixed source audio signals 120a-b, separating 304 the mixed source audio signals 120a-b, and storing 306 the blind source separation (BSS) filter set 130) may be referred as training the blind source separation (BSS) filter set 130. The electronic device 102 may train multiple blind source separation (BSS) filter sets 130 for different locations 118 and/or multiple users in a listening environment.

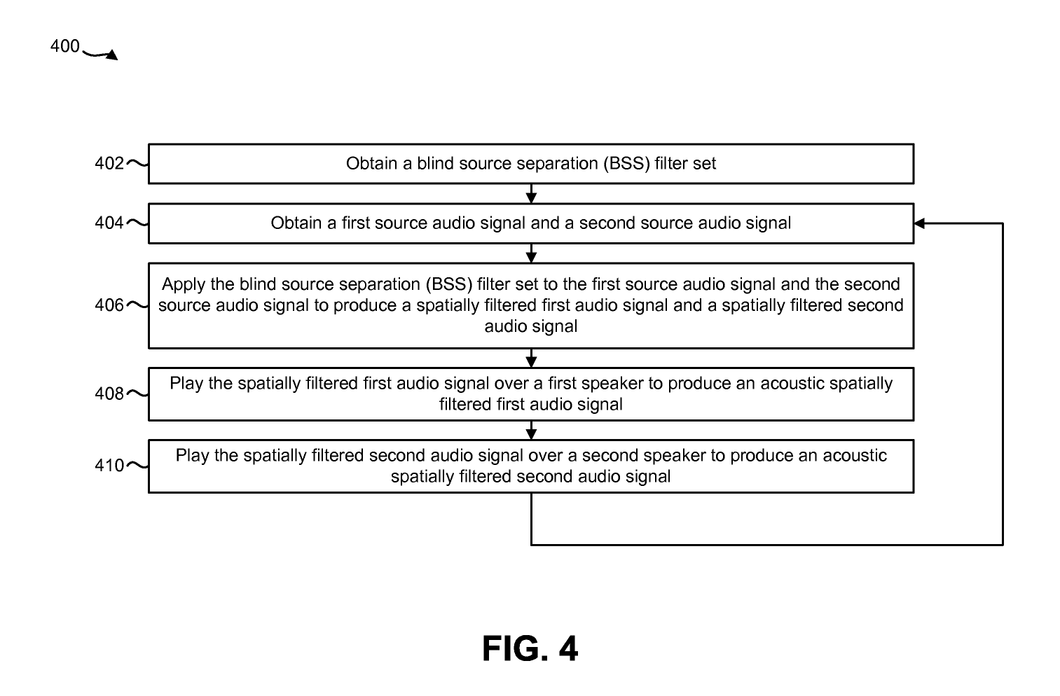

FIG. 4 is a flow diagram illustrating one configuration of a method 400 for blind source separation (BSS) based spatial filtering. An electronic device 202 may obtain 402 a blind source separation (BSS) filter set 230. For example, the electronic device 202 may perform the method 300 described above in FIG. 3. Alternatively, the electronic device 202 may receive the blind source separation (BSS) filter set 230 from another electronic device.

The electronic device 202 may transition to or function at runtime. The electronic device 202 may obtain 404 a first source audio signal 238 and a second source audio signal 240. For example, the electronic device 202 may obtain 404 the first source audio signal 238 and/or the second source audio signal 240 from internal memory, from an attached device (e.g., a portable audio player, from an optical media player (e.g., compact disc (CD) player, digital video disc (DVD) player, Blu-ray player, etc.), from a network (e.g., local area network (LAN), the Internet, etc.), from a wireless link to another device, etc. In some configurations, the electronic device 202 may obtain 404 the first source audio signal 238 and/or the second source audio signal 240 from the same source(s) that were used during training. In other configurations, the electronic device 202 may obtain 404 the first source audio signal 238 and/or the second source audio signal 240 from other source(s) than were used during training.

The electronic device 202 may apply 406 the blind source separation (BSS) filter set 230 to the first source audio signal 238 and to the second source audio signal 240 to produce spatially filtered audio signal A 234a and spatially filtered audio signal B 234b. For example, the electronic device 202 may filter the first source audio signal 238 and the second source audio signal 240 using transfer functions 226 or the blind source separation (BSS) filter set 230 that comprise an approximate inverse of the mixing and/or crosstalk that occurs in the training and/or runtime environment (e.g., at position A 214a and position B 214b).

The electronic device 202 may play 408 spatially filtered audio signal A 234a over a first speaker 208a to produce acoustic spatially filtered audio signal A 236a. For example, the electronic device 202 may provide spatially filtered audio signal A 234a to the first speaker 208a, which may convert it to an acoustic signal (e.g., acoustic spatially filtered audio signal A 236a).

The electronic device 202 may play 410 spatially filtered audio signal B 234b over a second speaker 208b to produce acoustic spatially filtered audio signal B 236b. For example, the electronic device 202 may provide spatially filtered audio signal B 234b to the second speaker 208b, which may convert it to an acoustic signal (e.g., acoustic spatially filtered audio signal B 236b).

Spatially filtered audio signal A 234a and spatially filtered audio signal B 234b may produce an isolated acoustic first source audio signal 284 at position A 214a and an isolated acoustic second source audio signal 286 at position B 214b. Since the filtering (performed by the filtering block/module 228 using a blind source separation (BSS) filter set 230) corresponds to an approximate inverse of the acoustic mixing from the speakers 208a-b to position A 214a and position B 214b, the transfer function from the first and second source audio signals 238, 240 to the position A 214a and position B 214b (e.g., to a user's ears) may be expressed as an identity matrix. A user at the location 218 including position A 214a and position B 214b may hear a good approximation of the first source audio signal 238 at one ear and the second source audio signal 240 at another ear. In accordance with the systems and methods disclosed herein, the blind source separation (BSS) filter set 230 models the inverse transfer function from the speakers 208a-b to a location 218 (e.g., position A 214a and position B 214b), without having to explicitly determine an inverse of a mixing matrix. The electronic device 202 may continue to obtain 404 and spatially filter new source audio 238, 240 before playing it on the speakers 208a-b. In one configuration, the electronic device 202 may not require retraining of the BSS filter set(s) 230 once runtime is entered.

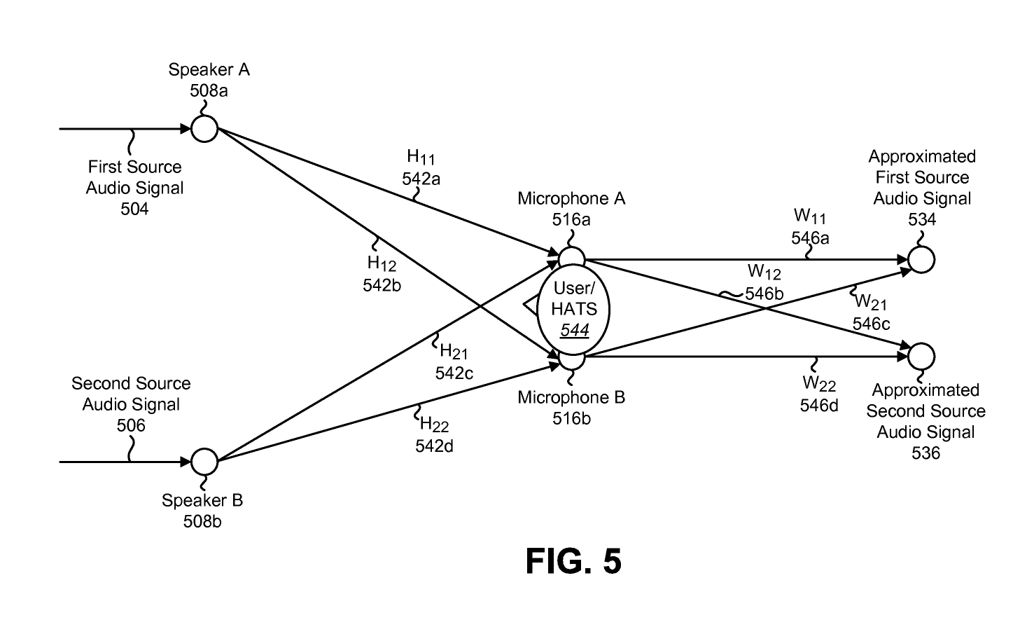

FIG. 5 is a diagram illustrating one configuration of blind source separation (BSS) filter training. More specifically, FIG. 5 illustrates one example of the systems and methods disclosed herein during training. A first source audio signal 504 may be played over speaker A 508a and a second source audio signal 506 may be played over speaker B 508b. Mixed source audio signals may be received at microphone A 516a and at microphone B 516b. In the configuration illustrated in FIG. 5, the microphones 516a-b are worn by a user 544 or included in a head and torso simulator (HATS) 544.

The H variables illustrated may represent the transfer functions from the speakers 508a-b to the microphones 516a-b. For example, H₁₁ 542a may represent the transfer function from speaker A 508a to microphone A 516a, H₁₂ 542b may represent the transfer function from speaker A 508a to microphone B 516b, H₂₁ 542c may represent the transfer function from speaker B 508b to microphone A 516a, and H₂₂ 542d may represent the transfer function from speaker B 508b to microphone B 516b. Therefore, a combined mixing matrix may be represented by H in Equation (1):

$$H = [ \begin{matrix}{H}_{11} & {H}_{12} \\ {H}_{21} & {H}_{22}\end{matrix} ] \qquad ( 1 )$$

The signals received at the microphones 516a-b may be mixed due to transmission over the air. It may be desirable to only listen to one of the channels (e.g., one signal) at a particular position (e.g., the position of microphone A 516a or the position of microphone B 516b). Therefore, an electronic device may reduce or cancel the mixing that takes place over the air. In other words, a blind source separation (BSS) algorithm may be used to determine the unmixing solution, which may then be used as an (approximate) inverted mixing matrix, H⁻¹.

As illustrated in FIG. 5, W₁₁ 546a may represent the transfer function from microphone A 516a to an approximated first source audio signal 534, W₁₂ 546b may represent the transfer function from microphone A 516a to an approximated second source audio signal 536, W₂₁ 546c may represent the transfer function from microphone B 516b to the approximated first source audio signal 534 and W₂₂ 546d may represent the transfer function from microphone B 516b to the approximated second source audio signal 536. The unmixing matrix may be represented by H⁻¹ in Equation (2):

$${H}^{- 1} = [ \begin{matrix}{W}_{11} & {W}_{12} \\ {W}_{21} & {W}_{22}\end{matrix} ] \qquad ( 2 )$$

Therefore, the product of H and H⁻¹ may be the identity matrix or close to it, as shown in Equation (3):

H·H⁻¹=I (3)

After unmixing using blind source separation (BSS) filtering, the approximated first source audio signal 534 and approximated second source audio signal 536 may respectively correspond to (e.g., closely approximate) the first source audio signal 504 and second source audio signal 506. In other words, the (learned or generated) blind source separation (BSS) filtering may perform unmixing.

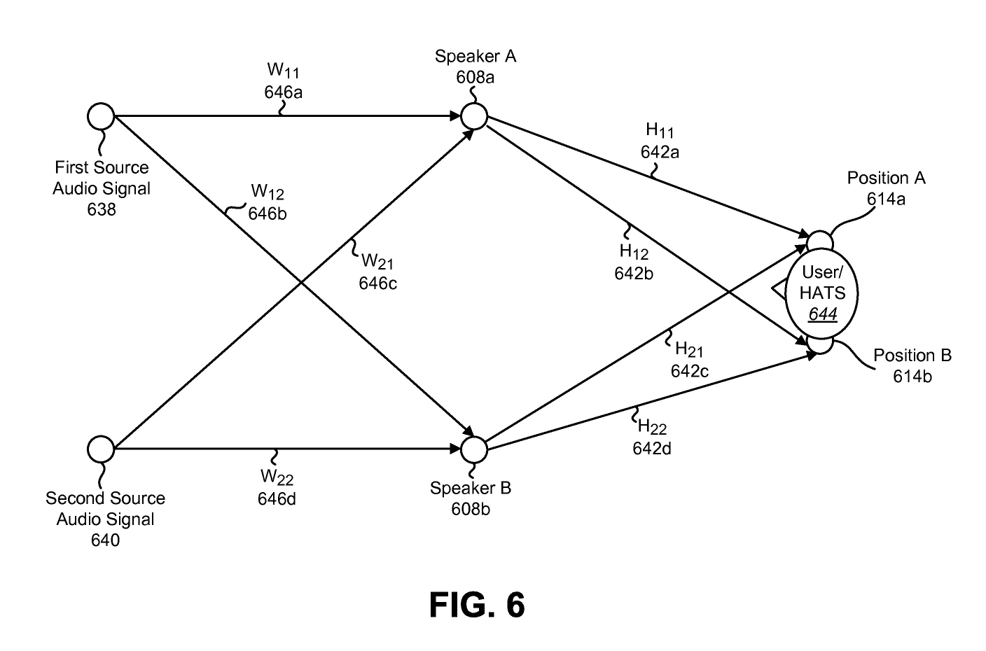

FIG. 6 is a diagram illustrating one configuration of blind source separation (BSS) based spatial filtering. More specifically, FIG. 6 illustrates one example of the systems and methods disclosed herein during runtime.

Instead of playing the first source audio signal 638 and second source audio signal 640 directly over speaker A 608a and speaker B 608b, respectively, an electronic device may spatially filter them with an unmixing blind source separation (BSS) filter set. In other words, the electronic device may preprocess the first source audio signal 638 and the second source audio signal 640 using the filter set determined during training. For example, the electronic device may apply a transfer function W₁₁ 646a to the first source audio signal 638 for speaker A 608a, a transfer function W₁₂ 646b to the first source audio signal 638 for speaker B 608b, a transfer function W₂₁ 646c to the second source audio signal 640 for speaker A 608a and a transfer function W₂₂ 646d to the second source audio signal 640 for speaker B 608b.

The spatially filtered signals may be then played over the speakers 608a-b. This filtering may produce a first acoustic spatially filtered audio signal from speaker A 608a and a second acoustic spatially filtered audio signal from speaker B 608b. The H variables illustrated may represent the transfer functions from the speakers 608a-b to position A 614a and position B 614b. For example, H₁₁ 642a may represent the transfer function from speaker A 608a to position A 614a, H₁₂ 642b may represent the transfer function from speaker A 608a to position B 614b, H₂₁ 642c may represent the transfer function from speaker B 608b to position A 614a, and H₂₂ 642d may represent the transfer function from speaker B 608b to position B 614b. Position A 614a may correspond to one ear of a user 644 (or HATS 644), while position B 614b may correspond to another ear of a user 644 (or HATS 644).

The signals received at the positions 614a-b may be mixed due to transmission over the air. However, because of the spatial filtering performed by applying the transfer functions W₁₁ 646a and W₁₂ 646b to the first source audio signal 638 and applying the transfer functions W₂₁ 646c and W₂₂ 646d to the second source audio signal 640, the acoustic signal at position A 614a may be an isolated acoustic first source audio signal that closely approximates the first source audio signal 638 and the acoustic signal at position B 614b may be an isolated acoustic second source audio signal that closely approximates the second source audio signal 640. This may allow a user 644 to only perceive the isolated acoustic first source audio signal at position A 614a and the isolated acoustic second source audio signal at position B 614b.

Therefore, an electronic device may reduce or cancel the mixing that takes place over the air. In other words, a blind source separation (BSS) algorithm may be used to determine the unmixing solution, which may then be used as an (approximate) inverted mixing matrix, H⁻¹. Since the blind source separation (BSS) filtering procedure may correspond to the (approximate) inverse of the acoustic mixing from the speakers 608a-b to the user 644, the transfer function of the whole procedure may be expressed as an identity matrix.

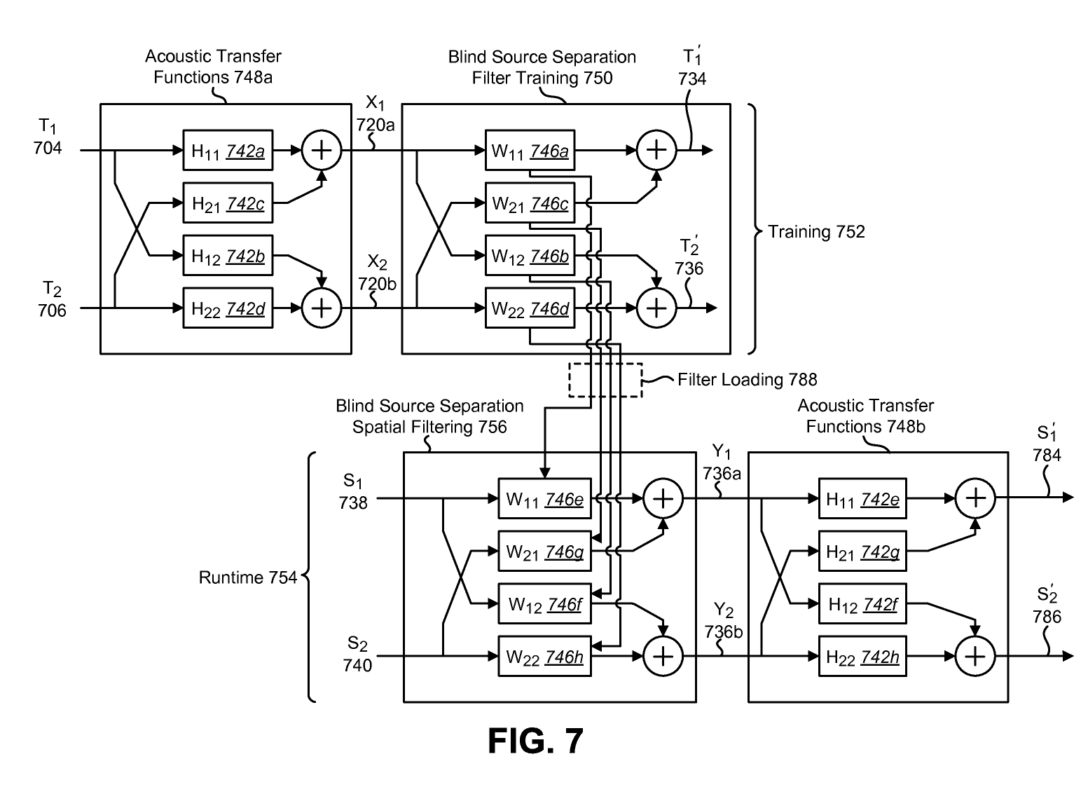

FIG. 7 is a block diagram illustrating one configuration of training 752 and runtime 754 in accordance with the systems and methods disclosed herein. During training 752 a first training signal T₁ 704 (e.g., a first source audio signal) may be played over a speaker and a second training signal T₂ 706 (e.g., a second source audio signal) may be played over another speaker. While traveling through the air, acoustic transfer functions 748a affect the first training signal T₁ 704 and the second training signal T₂ 706.

The H variables illustrated may represent the acoustic transfer functions 748a from the speakers to microphones as illustrated in Equation (1) above. For example, H₁₁ 742a may represent the acoustic transfer function affecting T₁ 704 as it travels from a first speaker to a first microphone, H₁₂ 742b may represent the acoustic transfer function affecting T₁ 704 from the first speaker to a second microphone, H₂₁ 742c may represent the acoustic transfer function affecting T₂ 706 from the second speaker to the first microphone, and H₂₂ 742d may represent the acoustic transfer function affecting T₂ 706 from the second speaker to the second microphone.

As is illustrated in FIG. 7, a first mixed source audio signal X₁ 720a (as received at the first microphone) may comprise a sum of T₁ 704 and T₂ 706 with the respective effect of the transfer functions H₁₁ 742a and H₂₁ 742c (e.g., X₁=T₁H₁₁+T₂H₂₁). A second mixed source audio signal X₂ 720b (as received at the second microphone) may comprise a sum of T₁ 704 and T₂ 706 with the respective effect of the transfer functions H₁₂ 742b and H₂₂ 742d (e.g., X₂=T₁H₁₂+T₂H₂₂).

An electronic device (e.g., electronic device 102) may perform blind source separation (BSS) filter training 750 using X₁ 720a and X₂ 720b. In other words, a blind source separation (BSS) algorithm may be used to determine an unmixing solution, which may then be used as an (approximate) inverted mixing matrix H⁻¹, as illustrated in Equation (2) above.

As illustrated in FIG. 7, W₁₁ 746a may represent the transfer function from X₁ 720a (at the first microphone, for example) to a first approximated training signal T₁′ 734 (e.g., an approximated first source audio signal), W₁₂ 746b may represent the transfer function from X₁ 720a to a second approximated training signal T₂′ 736 (e.g., an approximated second source audio signal), W₂₁ 746c may represent the transfer function from X₂ 720b (at the second microphone, for example) to T₁′ 734 and W₂₂ 746d may represent the transfer function from the second microphone to T₂′ 736. After unmixing using blind source separation (BSS) filtering, T₁′ 734 and T₂′ 736 may respectively correspond to (e.g., closely approximate) T₁ 704 and T₂ 706.

Once the blind source separation (BSS) transfer functions 746a-d are determined (e.g., upon the completion of training 752), the transfer functions 746a-d may be loaded in order to perform blind source separation (BSS) spatial filtering 756 for runtime 754 operations. For example, an electronic device may perform filter loading 788, where the transfer functions 746a-d are stored as a blind source separation (BSS) filter set 746e-h. For instance, the transfer functions W₁₁ 746a, W₁₂ 746b, W₂₁ 746c and W₂₂ 746d determined in training 752 may be respectively loaded (e.g., stored, transferred, obtained, etc.) as W₁₁ 746e, W₁₂ 746f, W₂₁ 746g and W₂₂ 746h for blind source separation (BSS) spatial filtering 756 at runtime 754.

During runtime 754, a first source audio signal S₁ 738 (which may or may not come from the same source as the first training signal T₁ 704) and a second source audio signal S₂ 740 (which may or may not come from the same source as the second training signal T₂ 706) may be spatially filtered with the blind source separation (BSS) filter set 746e-h. For example, an electronic device may apply the transfer function W₁₁ 746e to S₁ 738 for the first speaker, a transfer function W₁₂ 746f to S₁ 738 for the second speaker, a transfer function W₂₁ 746g to S₂ 740 for the first speaker and a transfer function W₂₂ 746h to S₂ 740 for the second speaker.

As is illustrated in FIG. 7, a first acoustic spatially filtered audio signal Y₁ 736a (as played at a first speaker) may comprise a sum of S₁ 738 and S₂ 740 with the respective effect of the transfer functions W₁₁ 746e and W₂₁ 746g (e.g., Y₁=S₁W₁₁+S₂W₂₁). A second acoustic spatially filtered audio signal Y₂ 736b (as played at a second speaker) may comprise a sum of S₁ 738 and S₂ 740 with the respective effect of the transfer functions W₁₂ 746f and W₂₂ 746h (e.g., Y₂=S₁W₁₂+S₂W₂₂).

Y₁ 736a and Y₂ 736b may be affected by the acoustic transfer functions 748b. For example, the acoustic transfer functions 748b represent how a listening environment can affect acoustic signals traveling through the air between the speakers and the (prior) position of the microphones used in training.

For example, H₁₁ 742e may represent the transfer function from Y₁ 736a to an isolated acoustic first source audio signal S₁′ 784 (at a first position), H₁₂ 742f may represent the transfer function from Y₁ 736a to an isolated acoustic second source audio signal S₂′ 786 (at a second position), H₂₁ 742g may represent the transfer function from Y₂ 736b to S₁′ 784, and H₂₂ 742h may represent the transfer function from Y₂ 736b to S₂′ 786. The first position may correspond to one ear of a user (e.g., the prior position of the first microphone), while the second position may correspond to another ear of a user (e.g., the prior position of the second microphone).

As is illustrated in FIG. 7, S₁′ 784 (at a first position) may comprise a sum of Y₁ 736a and Y₂ 736b with the respective effect of the transfer functions H₁₁ 742e and H₂₁ 742g (e.g., S₁′=Y₁H₁₁+Y₂H₂₁). S₂′ 786 (at a second position) may comprise a sum of Y₁ 736a and Y₂ 736b with the respective effect of the transfer functions H₁₂ 742f and H₂₂ 742h (e.g., S₂′=Y₁H₁₂+Y₂H₂₂).

However, because of the spatial filtering performed by applying the transfer functions W₁₁ 746e and W₁₂ 746f to S₁ 738 and applying the transfer functions W₂₁ 746g and W₂₂ 746h to S₂ 740, S₁′ 784 may closely approximate S₁ 738 and S₂′ 786 may closely approximate S₂ 740. In other words, the blind source separation (BSS) spatial filtering 756 may approximately invert the effects of the acoustic transfer functions 748b, thereby reducing or eliminating crosstalk between speakers at the first and second positions. This may allow a user to only perceive S₁′ 784 at the first position and S₂′ 786 at the second position.

Therefore, an electronic device may reduce or cancel the mixing that takes place over the air. In other words, a blind source separation (BSS) algorithm may be used to determine the unmixing solution, which may then be used as an (approximate) inverted mixing matrix, H⁻¹. Since the blind source separation (BSS) filtering procedure may correspond to the (approximate) inverse of the acoustic mixing from the speakers to a user, the transfer function of runtime 754 may be expressed as an identity matrix.

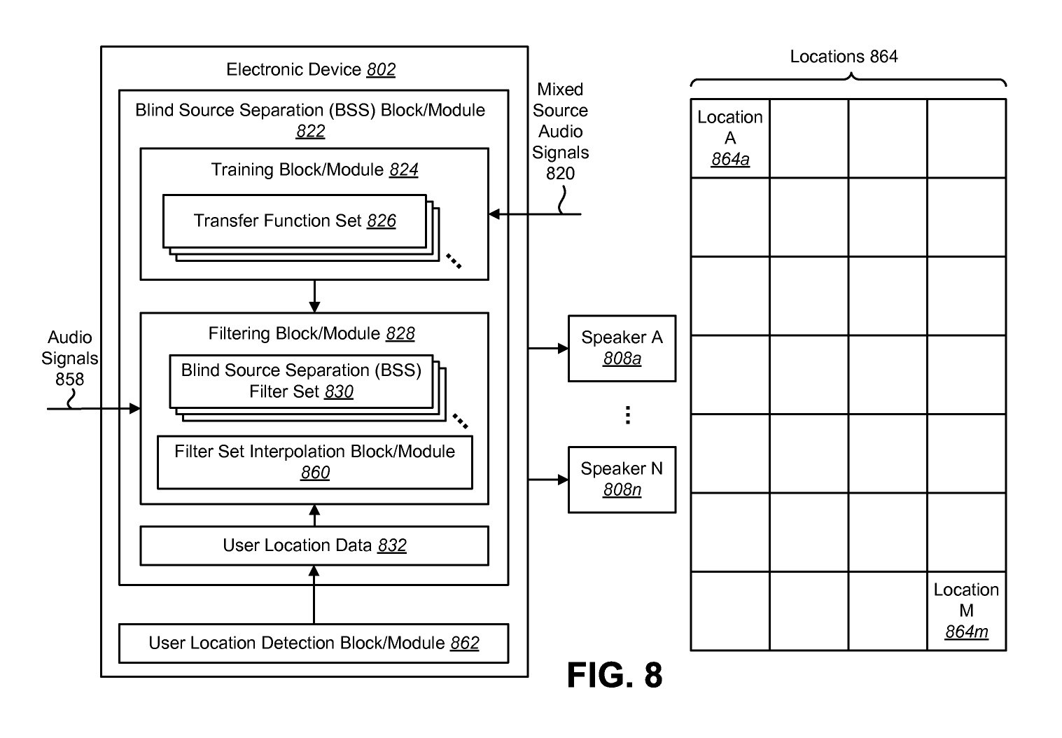

FIG. 8 is a block diagram illustrating one configuration of an electronic device 802 for blind source separation (BSS) based filtering for multiple locations 864. The electronic device 802 may include a blind source separation (BSS) block/module 822 and a user location detection block/module 862. The blind source separation (BSS) block/module 822 may include a training block/module 824, a filtering block/module 828 and/or user location data 832.

The training block/module 824 may function similarly to one or more of the training blocks/modules 124, 224 described above. The filtering block/module 828 may function similarly to one or more of the filtering blocks/modules 128, 228 described above.

In the configuration illustrated in FIG. 8, the blind source separation (BSS) block/module 822 may train (e.g., determine or generate) multiple transfer functions sets 826 and/or use multiple blind source separation (BSS) filter sets 830 corresponding to multiple locations 864. The locations 864 (e.g., distinct locations 864) may be located within a listening environment (e.g., a room, an area, etc.). Each of the locations 864 may include two corresponding positions. The two corresponding positions in each of the locations 864 may be associated with the positions of two microphones during training and/or with a user's ears during runtime.

During training for each location, such as location A 864a through location M 864m, the electronic device 802 may determine (e.g., train, generate, etc.) a transfer function set 826 that may be stored as a blind source separation (BSS) filter set 830 for use during runtime. For example, the electronic device 802 may play statistically independent audio signals from separate speakers 808a-n and may receive mixed source audio signals 820 from microphones in each of the locations 864a-m during training. Thus, the blind source separation (BSS) block/module 822 may generate multiple transfer function sets 826 corresponding to the locations 864a-m and multiple blind source separation (BSS) filter sets 830 corresponding to the locations 864a-m.

It should be noted that one pair of microphones may be used and placed in each location 864a-m during multiple training periods or sub-periods. Alternatively, multiple pairs of microphones respectively corresponding to each location 864a-m may be used. It should also be noted that multiple pairs of speakers 808a-n may be used. In some configurations, only one pair of the speakers 808a-n may be used at a time during training.

It should be noted that training may include multiple parallel trainings for multiple pairs of speakers 808a-n and/or multiple pairs of microphones in some configurations. For example, one or more transfer function sets 826 may be generated during multiple training periods with multiple pairs of speakers 808a-n in a speaker array. This may generate one or more blind source separation (BSS) filter sets 830 for use during runtime. Using multiple pairs of speakers 808a-n and microphones may improve the robustness of the systems and methods disclosed herein. For example, if multiple pairs of speakers 808a-n and microphones are used, if a speaker 808 is blocked, a binaural stereo image may still be produced for a user.

In the case of multiple parallel trainings, the electronic device 802 may apply the multiple blind source separation (BSS) filter sets 830 to the audio signals 858 (e.g., first source audio signal and second source audio signal) to produce multiple pairs of spatially filtered audio signals. The electronic device 802 may also play these multiple pairs of spatially filtered audio signals over multiple pairs of speakers 808a-n to produce an isolated acoustic first source audio signal at a first position (in a location 864) and an isolated acoustic second source audio signal at a second position (in a location 864).

During training at each location 864a-m, the user location detection block/module 862 may determine and/or store user location data 832. The user location detection block/module 862 may use any suitable technology for determining the location of a user (or location of the microphones) during training. For example, the user location detection block/module 862 may use one or more microphones, cameras, pressure sensors, motion detectors, heat sensors, switches, receivers, global positioning satellite (GPS) devices, RF transmitters/receivers, etc., to determine user location data 832 corresponding to each location 864a-m.

At runtime, the electronic device 802 may select a blind source separation (BSS) filter set 830 and/or may generate an interpolated blind source separation (BSS) filter set 830 to produce a binaural stereo image at a location 864 using the audio signals 858. For example, the user location detection block/module 862 may provide user location data 832 during runtime that indicates the location of a user. If the current user location corresponds to one of the predetermined training locations 864a-m (within a threshold distance, for example), the electronic device 802 may select and apply a predetermined blind source separation (BSS) filter set 830 corresponding to the predetermined training location 864. This may provide a binaural stereo image for a user at the corresponding predetermined location.

However, if the user's current location is in between the predetermined training locations 864 and does not correspond (within a threshold distance, for example) to one of the predetermined training locations 864, the filter set interpolation block/module 860 may interpolate between two or more predetermined blind source separation (BSS) filter sets 830 to determine (e.g., produce) an interpolated blind source separation (BSS) filter set 830 that better corresponds to the current user location. This interpolated blind source separation (BSS) filter set 830 may provide the user with a binaural stereo image while in between two or more predetermined locations 864a-m.

The functionality of the electronic device 802 illustrated in FIG. 8 may be implemented in a single electronic device or may be implemented in a plurality of separate electronic devices. In one configuration, for example, a headset including microphones may include the training block/module 824 and an audio receiver or television may include the filtering block/module 828. Upon receiving mixed source audio signals, the headset may generate a transfer function set 826 and transmit it to the television or audio receiver, which may store the transfer function set 826 as a blind source separation (BSS) filter set 830. Then, the television or audio receiver may use the blind source separation (BSS) filter set 830 to spatially filter the audio signals 858 to provide a binaural stereo image for a user.

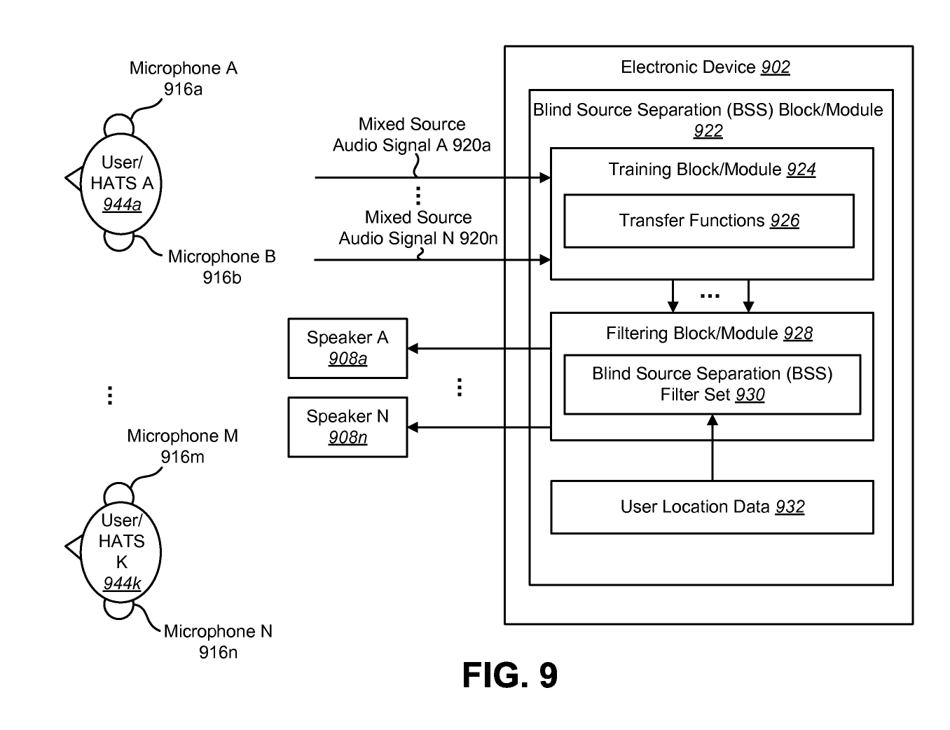

FIG. 9 is a block diagram illustrating one configuration of an electronic device 902 for blind source separation (BSS) based filtering for multiple users or HATS 944. The electronic device 902 may include a blind source separation (BSS) block/module 922. The blind source separation (BSS) block/module 922 may include a training block/module 924, a filtering block/module 928 and/or user location data 932.

The training block/module 924 may function similarly to one or more of the training block/module 124, 224, 824 described above. In some configurations, the training block/module 924 may obtain transfer functions (e.g., coefficients) for multiple locations (e.g., multiple concurrent users 944a-k). In a two-user case, for example, the training block/module 924 may train a 4×4 matrix using four loudspeakers 908 with four independent sources (e.g., statistically independent source audio signals). After convergence, the resulting transfer functions 926 (resulting in HW=WH=I) may be similar to the two-user case, but with a rank of four instead of two. It should be noted that the input left and right binaural signals (e.g., first source audio signal and second source audio signal) for each user 944a-k can be the same or different. The filtering block/module 928 may function similarly to one or more of the filtering block/module 128, 228, 828 described above.

In the configuration illustrated in FIG. 9, the blind source separation (BSS) block/module 922 may determine or generate transfer functions 926 and/or use a blind source separation (BSS) filter corresponding to multiple users or HATS 944a-k. Each of the users or HATS 944a-k may have two corresponding microphones 916. For example, user/HATS A 944a may have corresponding microphones A and B 916a-b and user/HATS K 944k may have corresponding microphones M and N 916m-n. The two corresponding microphones 916 for each of the users or HATS 944a-k may be associated with the positions of a user's 944 ears during runtime.

During training for the one or more users or HATS 944, such as user/HATS A 944a through user/HATS K 944k, the electronic device 902 may determine (e.g., train, generate, etc.) transfer functions 926 that may be stored as a blind source separation (BSS) filter set 930 for use during runtime. For example, the electronic device 902 may play statistically independent audio signals from separate speakers 908a-n (e.g., a speaker array 908a-n) and may receive mixed source audio signals 920a-n from microphones 916a-n for each of the users or HATS 944a-k during training. It should be noted that one pair of microphones may be used and placed at each user/HATS 944a-k during training (and/or multiple training periods or sub-periods, for example). Alternatively, multiple pairs of microphones respectively corresponding to each user/HATS 944a-k may be used. It should also be noted that multiple pairs of speakers 908a-n or a speaker array 908a-n may be used. In some configurations, only one pair of the speakers 908a-n may be used at a time during training. Thus, the blind source separation (BSS) block/module 922 may generate one or more transfer function sets 926 corresponding to the users or HATS 944a-k and/or one or more blind source separation (BSS) filter sets 930 corresponding to the users or HATS 944a-k.

During training at each user/HATS 944a-k, user location data 932 may be determined and/or stored. The user location data 932 may indicate the location(s) of one or more users/HATS 944. This may be done as described above in connection with FIG. 8 for multiple users/HATS 944.

At runtime, the electronic device 902 may utilize the blind source separation (BSS) filter set 930 and/or may generate one or more interpolated blind source separation (BSS) filter sets 930 to produce one or more binaural stereo images for one or more users/HATS 944 using audio signals. For example, the user location data 932 may indicate the location of one or more user(s) 944 during runtime. In some configurations, interpolation may be performed similarly as described above in connection with FIG. 8.

In one example, the electronic device 902 may apply a blind source separation (BSS) filter set 930 to a first source audio signal and to a second source audio signal to produce multiple spatially filtered audio signals. The electronic device 902 may then play the multiple spatially filtered audio signals over a speaker array 908a-n to produce multiple isolated acoustic first source audio signals and multiple isolated acoustic second source audio signals at multiple position pairs (e.g., where multiple pairs of microphones 916 were placed during training) for multiple users 944a-k.

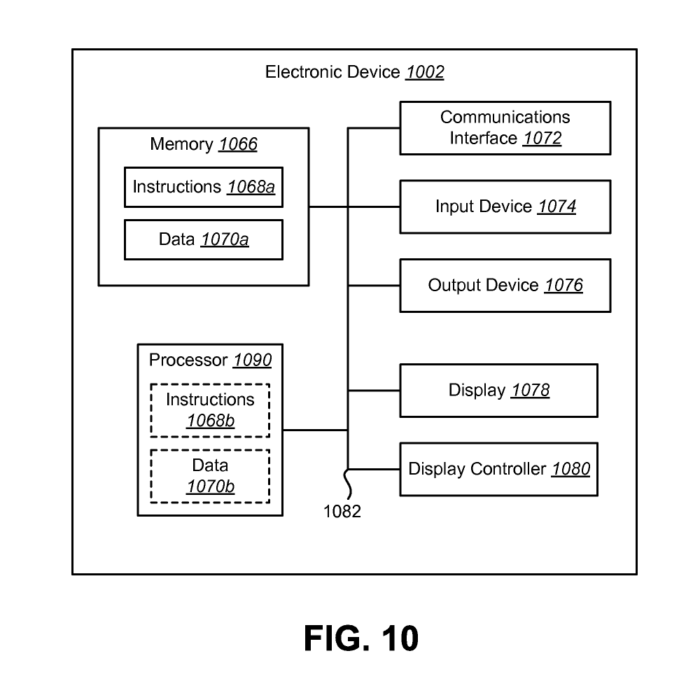

FIG. 10 illustrates various components that may be utilized in an electronic device 1002. The illustrated components may be located within the same physical structure or in separate housings or structures. The electronic device 1002 may be configured similar to the one or more electronic devices 102, 202, 802, 902 described previously. The electronic device 1002 includes a processor 1090. The processor 1090 may be a general purpose single- or multi-chip microprocessor (e.g., an ARM), a special purpose microprocessor (e.g., a digital signal processor (DSP)), a microcontroller, a programmable gate array, etc. The processor 1090 may be referred to as a central processing unit (CPU). Although just a single processor 1090 is shown in the electronic device 1002 of FIG. 10, in an alternative configuration, a combination of processors (e.g., an ARM and DSP) could be used.

The electronic device 1002 also includes memory 1066 in electronic communication with the processor 1090. That is, the processor 1090 can read information from and/or write information to the memory 1066. The memory 1066 may be any electronic component capable of storing electronic information. The memory 1066 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 1070a and instructions 1068a may be stored in the memory 1066. The instructions 1068a may include one or more programs, routines, sub-routines, functions, procedures, etc. The instructions 1068a may include a single computer-readable statement or many computer-readable statements. The instructions 1068a may be executable by the processor 1090 to implement one or more of the methods 300, 400 described above. Executing the instructions 1068a may involve the use of the data 1070a that is stored in the memory 1066. FIG. 10 shows some instructions 1068b and data 1070b being loaded into the processor 1090 (which may come from instructions 1068a and data 1070a).

The electronic device 1002 may also include one or more communication interfaces 1072 for communicating with other electronic devices. The communication interfaces 1072 may be based on wired communication technology, wireless communication technology, or both. Examples of different types of communication interfaces 1072 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, an IEEE 802.11 wireless communication adapter and so forth.

The electronic device 1002 may also include one or more input devices 1074 and one or more output devices 1076. Examples of different kinds of input devices 1074 include a keyboard, mouse, microphone, remote control device, button, joystick, trackball, touchpad, lightpen, etc. Examples of different kinds of output devices 1076 include a speaker, printer, etc. One specific type of output device which may be typically included in an electronic device 1002 is a display device 1078. Display devices 1078 used with configurations disclosed herein may utilize any suitable image projection technology, such as a cathode ray tube (CRT), liquid crystal display (LCD), light-emitting diode (LED), gas plasma, electroluminescence, or the like. A display controller 1080 may also be provided, for converting data stored in the memory 1066 into text, graphics, and/or moving images (as appropriate) shown on the display device 1078.

The various components of the electronic device 1002 may be coupled together by one or more buses, which may include a power bus, a control signal bus, a status signal bus, a data bus, etc. For simplicity, the various buses are illustrated in FIG. 10 as a bus system 1082. It should be noted that FIG. 10 illustrates only one possible configuration of an electronic device 1002. Various other architectures and components may be utilized.

In accordance with the systems and methods disclosed herein, a circuit, in an electronic device (e.g., mobile device), may be adapted to receive a first mixed source audio signal and a second mixed source audio signal. The same circuit, a different circuit, or a second section of the same or different circuit may be adapted to separate the first mixed source audio signal and the second mixed source audio signal into an approximated first source audio signal and an approximated second source audio signal using blind source separation (BSS). The portion of the circuit adapted to separate the mixed source audio signals may be coupled to the portion of a circuit adapted to receive the mixed source audio signals, or they may be the same circuit. Additionally, the same circuit, a different circuit, or a third section of the same or different circuit may be adapted to store transfer functions used during the blind source separation (BSS) as a blind source separation (BSS) filter set. The portion of the circuit adapted to store transfer functions may be coupled to the portion of a circuit adapted to separate the mixed source audio signals, or they may be the same circuit.

In addition, the same circuit, a different circuit, or a fourth section of the same or different circuit may be adapted to obtain a first source audio signal and a second source audio signal. The same circuit, a different circuit, or a fifth section of the same or different circuit may be adapted to apply the blind source separation (BSS) filter set to the first source audio signal and the second source audio signal to produce a spatially filtered first audio signal and a spatially filtered second audio signal. The portion of the circuit adapted to apply the blind source separation (BSS) filter may be coupled to the portion of a circuit adapted to obtain the first and second source audio signals, or they may be the same circuit. Additionally or alternatively, the portion of the circuit adapted to apply the blind source separation (BSS) filter may be coupled to the portion of a circuit adapted to store the transfer functions, or they may be the same circuit. The same circuit, a different circuit, or a sixth section of the same or different circuit may be adapted to play the spatially filtered first audio signal over a first speaker to produce an acoustic spatially filtered first audio signal and to play the spatially filtered second audio signal over a second speaker to produce an acoustic spatially filtered second audio signal. The portion of the circuit adapted to play the spatially filtered audio signals may be coupled to the portion of a circuit adapted to apply the blind source separation (BSS) filter set, or they may be the same circuit.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any non-transitory tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 3 and FIG. 4, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for blind source separation based spatial filtering on an electronic device, comprising:
obtaining a first source audio signal and a second source audio signal;
applying a blind source separation filter set to the first source audio signal and to the second source audio signal to produce a spatially filtered first audio signal and a spatially filtered second audio signal;
playing the spatially filtered first audio signal over a first speaker to produce an acoustic spatially filtered first audio signal; and
playing the spatially filtered second audio signal over a second speaker to produce an acoustic spatially filtered second audio signal, wherein the acoustic spatially filtered first audio signal and the acoustic spatially filtered second audio signal produce an isolated acoustic first source audio signal at a first position and an isolated acoustic second source audio signal at a second position.

2. The method of claim 1, further comprising training the blind source separation filter set.

3. The method of claim 2, wherein training the blind source separation filter set comprises:
receiving a first mixed source audio signal at a first microphone at the first position and second mixed source audio signal at a second microphone at the second position;
separating the first mixed source audio signal and the second mixed source audio signal into an approximated first source audio signal and an approximated second source audio signal using blind source separation; and
storing transfer functions used during the blind source separation as the blind source separation filter set for a location associated with the first position and the second position.

4. The method of claim 3, wherein the blind source separation is one of independent vector analysis (IVA), independent component analysis (ICA) and a multiple adaptive decorrelation algorithm.

5. The method of claim 3, further comprising:
training multiple blind source separation filter sets, each filter set corresponding to a distinct location; and
determining which blind source separation filter set to use based on user location data.

6. The method of claim 5, further comprising determining an interpolated blind source separation filter set by interpolating between the multiple blind source separation filter sets when a current location of a user is in between the distinct locations associated with the multiple blind source separation filter sets.

7. The method of claim 3, wherein the first microphone and the second microphone are included in a head and torso simulator (HATS) to model a user's ears during training.

8. The method of claim 2, wherein the training is performed using multiple pairs of microphones and multiple pairs of speakers.

9. The method of claim 2, wherein the training is performed for multiple users.

10. The method of claim 1, wherein the first position corresponds to one ear of a user and the second position corresponds to another ear of the user.

11. The method of claim 1, further comprising:
applying the blind source separation filter set to the first source audio signal and to the second source audio signal to produce multiple pairs of spatially filtered audio signals; and
playing the multiple pairs of spatially filtered audio signals over multiple pairs of speakers to produce the isolated acoustic first source audio signal at the first position and the isolated acoustic second source audio signal at the second position.

12. The method of claim 1, further comprising:
applying the blind source separation filter set to the first source audio signal and to the second source audio signal to produce multiple spatially filtered audio signals; and
playing the multiple spatially filtered audio signals over a speaker array to produce multiple isolated acoustic first source audio signals and multiple isolated acoustic second source audio signals at multiple position pairs for multiple users.

13. An electronic device configured for blind source separation based spatial filtering, comprising:
a processor;
memory in electronic communication with the processor;
instructions stored in the memory, the instructions being executable to:
obtain a first source audio signal and a second source audio signal;
apply a blind source separation filter set to the first source audio signal and to the second source audio signal to produce a spatially filtered first audio signal and a spatially filtered second audio signal;
play the spatially filtered first audio signal over a first speaker to produce an acoustic spatially filtered first audio signal; and
play the spatially filtered second audio signal over a second speaker to produce an acoustic spatially filtered second audio signal, wherein the acoustic spatially filtered first audio signal and the acoustic spatially filtered second audio signal produce an isolated acoustic first source audio signal at a first position and an isolated acoustic second source audio signal at a second position.

14. The electronic device of claim 13, wherein the instructions are further executable to train the blind source separation filter set.

15. The electronic device of claim 14, wherein training the blind source separation filter set comprises:
receiving a first mixed source audio signal at a first microphone at the first position and second mixed source audio signal at a second microphone at the second position;
separating the first mixed source audio signal and the second mixed source audio signal into an approximated first source audio signal and an approximated second source audio signal using blind source separation; and
storing transfer functions used during the blind source separation as the blind source separation filter set for a location associated with the first position and the second position.

16. The electronic device of claim 15, wherein the blind source separation is one of independent vector analysis (IVA), independent component analysis (ICA) and a multiple adaptive decorrelation algorithm.

17. The electronic device of claim 15, wherein the instructions are further executable to:
train multiple blind source separation filter sets, each filter set corresponding to a distinct location; and
determine which blind source separation filter set to use based on user location data.

18. The electronic device of claim 17, wherein the instructions are further executable to determine an interpolated blind source separation filter set by interpolating between the multiple blind source separation filter sets when a current location of a user is in between the distinct locations associated with the multiple blind source separation filter sets.

19. The electronic device of claim 15, wherein the first microphone and the second microphone are included in a head and torso simulator (HATS) to model a user's ears during training.

20. The electronic device of claim 14, wherein the training is performed using multiple pairs of microphones and multiple pairs of speakers.

21. The electronic device of claim 14, wherein the training is performed for multiple users.

22. The electronic device of claim 13, wherein the first position corresponds to one ear of a user and the second position corresponds to another ear of the user.

23. The electronic device of claim 13, wherein the instructions are further executable to:
apply the blind source separation filter set to the first source audio signal and to the second source audio signal to produce multiple pairs of spatially filtered audio signals; and
play the multiple pairs of spatially filtered audio signals over multiple pairs of speakers to produce the isolated acoustic first source audio signal at the first position and the isolated acoustic second source audio signal at the second position.

24. The electronic device of claim 13, wherein the instructions are further executable to:
apply the blind source separation filter set to the first source audio signal and to the second source audio signal to produce multiple spatially filtered audio signals; and
play the multiple spatially filtered audio signals over a speaker array to produce multiple isolated acoustic first source audio signals and multiple isolated acoustic second source audio signals at multiple position pairs for multiple users.

25. A computer-program product for blind source separation based spatial filtering, comprising a non-transitory tangible computer-readable medium having instructions thereon, the instructions comprising:
code for causing an electronic device to obtain a first source audio signal and a second source audio signal;
code for causing the electronic device to apply a blind source separation filter set to the first source audio signal and to the second source audio signal to produce a spatially filtered first audio signal and a spatially filtered second audio signal;
code for causing the electronic device to play the spatially filtered first audio signal over a first speaker to produce an acoustic spatially filtered first audio signal; and
code for causing the electronic device to play the spatially filtered second audio signal over a second speaker to produce an acoustic spatially filtered second audio signal, wherein the acoustic spatially filtered first audio signal and the acoustic spatially filtered second audio signal produce an isolated acoustic first source audio signal at a first position and an isolated acoustic second source audio signal at a second position.

26. The computer-program product of claim 25, wherein the instructions further comprise code for causing the electronic device to train the blind source separation filter set.

27. The computer-program product of claim 26, wherein the code for causing the electronic device to train the blind source separation filter set comprises:
code for causing the electronic device to receive a first mixed source audio signal at a first microphone at the first position and second mixed source audio signal at a second microphone at the second position;
code for causing the electronic device to separate the first mixed source audio signal and the second mixed source audio signal into an approximated first source audio signal and an approximated second source audio signal using blind source separation; and
code for causing the electronic device to store transfer functions used during the blind source separation as the blind source separation filter set for a location associated with the first position and the second position.

28. The computer-program product of claim 27, wherein the instructions further comprise:
code for causing the electronic device to train multiple blind source separation filter sets, each filter set corresponding to a distinct location; and
code for causing the electronic device to determine which blind source separation filter set to use based on user location data.

29. The computer-program product of claim 28, wherein the instructions further comprise code for causing the electronic device to determine an interpolated blind source separation filter set by interpolating between the multiple blind source separation filter sets when a current location of a user is in between the distinct locations associated with the multiple blind source separation filter sets.

30. The computer-program product of claim 25, wherein the first position corresponds to one ear of a user and the second position corresponds to another ear of the user.

31. An apparatus for blind source separation based spatial filtering, comprising:
means for obtaining a first source audio signal and a second source audio signal;
means for applying a blind source separation filter set to the first source audio signal and to the second source audio signal to produce a spatially filtered first audio signal and a spatially filtered second audio signal;
means for playing the spatially filtered first audio signal over a first speaker to produce an acoustic spatially filtered first audio signal; and
means for playing the spatially filtered second audio signal over a second speaker to produce an acoustic spatially filtered second audio signal, wherein the acoustic spatially filtered first audio signal and the acoustic spatially filtered second audio signal produce an isolated acoustic first source audio signal at a first position and an isolated acoustic second source audio signal at a second position.

32. The apparatus of claim 31, further comprising means for training the blind source separation filter set.

33. The apparatus of claim 32, wherein the means for training the blind source separation filter set comprise:
means for receiving a first mixed source audio signal at a first microphone at the first position and second mixed source audio signal at a second microphone at the second position;
means for separating the first mixed source audio signal and the second mixed source audio signal into an approximated first source audio signal and an approximated second source audio signal using blind source separation; and
means for storing transfer functions used during the blind source separation as the blind source separation filter set for a location associated with the first position and the second position.

34. The apparatus of claim 33, further comprising:
means for training multiple blind source separation filter sets, each filter set corresponding to a distinct location; and
means for determining which blind source separation filter set to use based on user location data.

35. The apparatus of claim 34, further comprising means for determining an interpolated blind source separation filter set by interpolating between the multiple blind source separation filter sets when a current location of a user is in between the distinct locations associated with the multiple blind source separation filter sets.

36. The apparatus of claim 31, wherein the first position corresponds to one ear of a user and the second position corresponds to another ear of the user.
